(19) United States
(12) Patent Application Publication
(10) Pub. No.: US 2014/0059941 A1
(43) Pub. Date: Mar. 6, 2014

(54) FLEXIBLE WIRE OR METAL REINFORCED WEATHERSTRIP WITH INTEGRAL METHOD FOR CONTROLLING NEUTRAL AXIS

(71) Applicant: Marc Brookman, Livonia, MI (US)

(72) Inventor: Marc Brookman, Livonia, MI (US)

(73) Assignee: COOPER-STANDARD AUTOMOTIVE INC., Novi, MI (US)

(21) Appl. No.: 14/111,700

(22) PCT Filed: Apr. 5, 2012
(86) PCT No.: PCT/US12/32381

§ 371 Date: Oct. 14, 2013

(51) Int. Cl. B60J 10/00; E06B 7/23

(52) U.S. Cl. CPC B60J 10/0002; B60J 10/0014; E06B 7/2314; B60J 10/0011
USPC 49/490.1; 264/171.17

(57) ABSTRACT

A weatherstrip includes an elastomeric body having a first material that encapsulates a carrier. A second material having a higher hardness than the first material of the body is selectively positioned at a predetermined location in the body to support compressive loads imposed on the body. In this manner, the neutral axis of the weatherstrip can be controlled by selective location of the second material in the cross-section.

### BACKGROUND OF THE INVENTION

This disclosure relates to a weatherstrip, and particularly one having a generally channel-shaped body used to secure a seal or cover a flange of a vehicle. Oftentimes, such strips include a seal lip or bulb extending from a portion thereof to seal or cover one portion of a vehicle relative to another.

A generally U-shaped channel typically incorporates a carrier or core, such as a metal core or carrier, which is then encapsulated at least partially by a first material. The material is oftentimes an elastomeric material such as a rubber or plastic. The assembly is preferably formed through an extruding process.

When a carrier is designed in a weatherstrip, it is strategically positioned so that the backbone of the carrier controls the neutral axis of the surrounding profile. A poorly positioned or single direction supporting backbone can cause the seal bulb or seal lips of the weatherstrip profile to buckle, wrinkle, or move in an undesired direction. Moreover, depending on the type of carrier used, the backbone can withstand either tension, compression, or both.

One of the most economical types of carrier is a wire carrier. Although a wire carrier is desirable from the perspective of cost, the wire carrier cannot support a compressive load and thus has limited ability to control the neutral axis of the weatherstrip. The same is true with some lanced and stretched carriers so that their use is limited because of the inability to adequately support a compressive load. Consequently, a need exists for a flexible weatherstrip carrier to use a lower cost carrier while still allowing the control of location of the neutral axis.

### SUMMARY OF THE INVENTION

A weatherstrip includes a generally U-shaped body having first and second legs interconnected by a third leg that forms a cavity for receipt over an associated mounting flange of a vehicle. A flexible carrier is received in the body for added strength and is unable to support compressive loads imposed on the body. A second material having a higher hardness than the first material of the body is selectively positioned at a predetermined location in the U-shaped body for supporting compressive loads and thereby assisting in the control of the location of the neutral axis of the weatherstrip.

The second material is one of a rubber, plastic, or thermoplastic. Preferably, the second material is a rubber having a higher durometer than the first material of the remainder of the body, and more preferably on the order of Shore A hardness of 85-95.

The carrier is preferably a wire, but may be a lanced and stretched metal carrier.

A method of controlling a neutral axis of the weatherstrip that allows a low cost carrier to be employed includes providing a carrier, encapsulating the carrier in an elastomeric first material, and including a second material having a higher hardness than the first material.

The second material preferably defines a minor portion of the body relative to the first material.

Preferably, the first and second materials are co-extruded on the carrier.

A primary benefit of the disclosure is the ability to use a low-cost carrier in a situation where control of the neutral axis is required.

Another advantage is the ability to easily incorporate the harder material into the weatherstrip.

Still another advantage resides in the ability to easily alter the location of the second material.

Yet another advantage relates to having tension and compression carrying capacities located in different areas of the carrier.

Still other benefits and advantages of the invention will become apparent to those skilled in the art upon reading and understanding the following detailed description.

### BRIEF DESCRIPTION OF THE DRAWINGS

FIG. 1 is a perspective view of a weatherstrip according to the present invention.

FIG. 2 is a longitudinal cross-sectional view, taken generally along the lines 2-2, of FIG. 1.

FIG. 3 is a cross-sectional view of another weatherstrip using the concepts of the present disclosure.

### DETAILED DESCRIPTION OF THE PREFERRED EMBODIMENTS

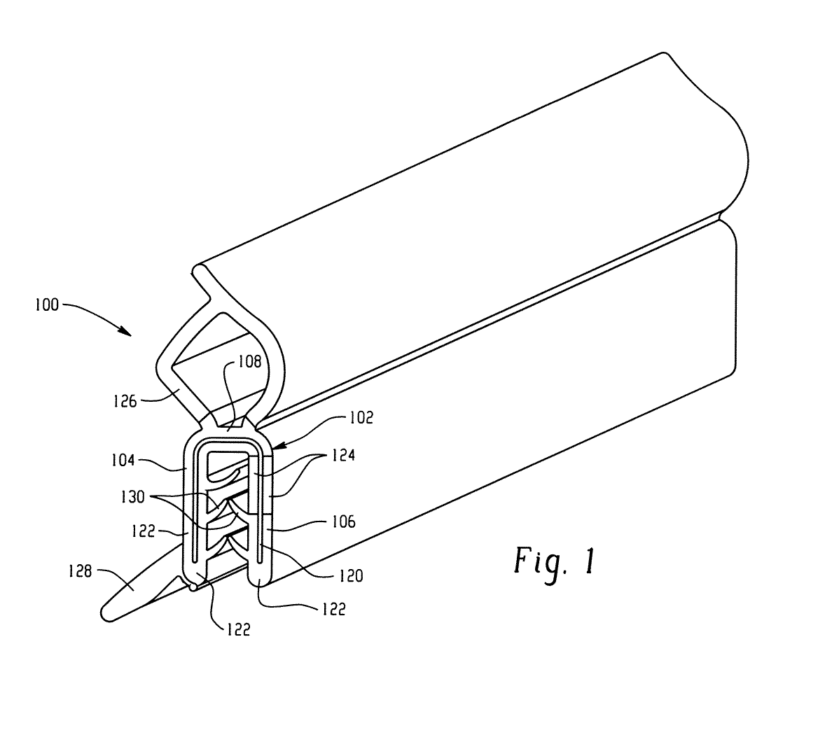

As shown in FIGS. 1-3, a weatherstrip 100 includes an elongated body 102 the preferably has a channel or generally U-shaped conformation. That is, the body is comprised of first and second generally parallel legs 104, 106 that are interconnected at one end by a third or interconnecting leg 108 to form a cavity 110. Preferably, the body includes a reinforcing member or core 120. In a more preferred arrangement, the core is a wire carrier or cord such as a composite cord, although other selected cores that do not carry or limited compressive loads imposed on the body are also contemplated. For example, the core may also adopt a generally U-shaped cross-section where the metal core may be lanced and stretched and the semi-solid backbone of such a lanced and stretched carrier limits the compression carrying capacity of this carrier. However, the wire carrier or cord is preferred in some instances because of the reduced cost associated therewith.

Received about a majority of the core is a first material, preferably an elastomeric material 122. Any suitable elastomer such as rubber or plastic (either a thermoset or thermoplastic) may be used. Again, this first material covers the major portion of the core. A second material 124, which is either an elastomeric or plastic material such as a thermosetting rubber, TPR, TPE, or TPV is provided or located at a preselected position in the cross-section of the body. The second material is harder than the first material and thus is capable of handling the compressive loads and allowing a less expensive core to be used for control of or assisting in the control of a desired position of the neutral axis of the weatherstrip, for example, to keep an associated seal bulb integrated into the weatherstrip from buckling.

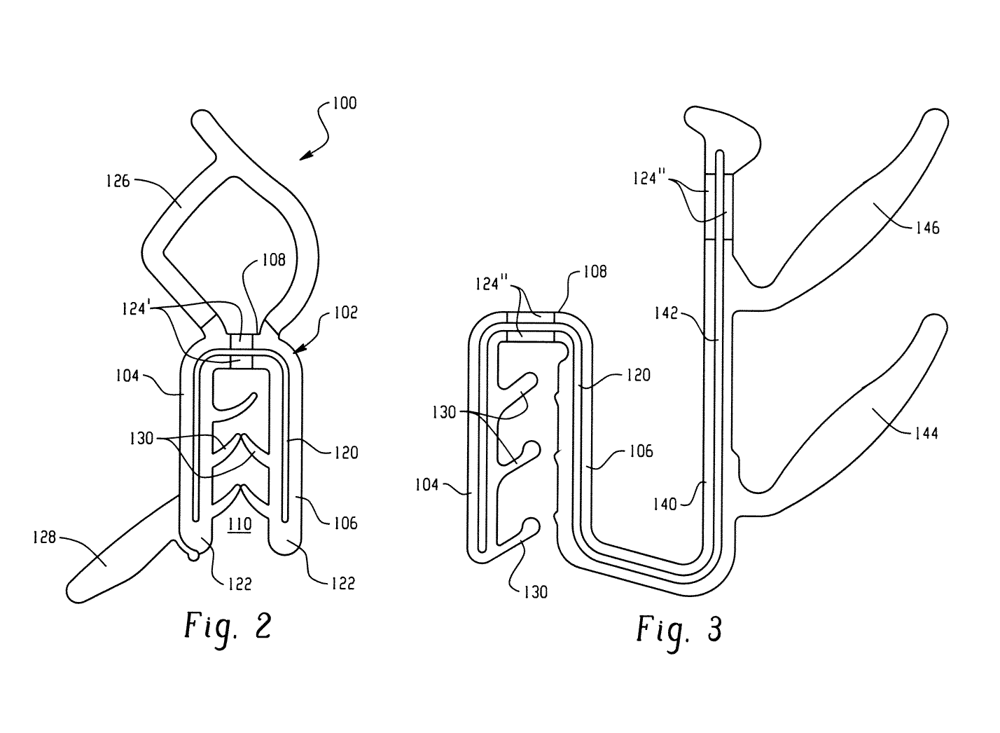

As illustrated in FIG. 2, the second material 124 is provided over the core, and over only a minor portion of the cross-section thereof. As shown, the second or harder material preferably extends across an entire cross-sectional portion of the second leg of the body so that compressive forces, for example from sponge rubber seal 126, can be transmitted through the body, and particularly through the second leg. It will be further appreciated that the second material 124 may be located at other positions on the body, i.e., other locations along the first or second legs 104, 106 or the interconnecting leg 108, and as represented by reference numeral 124′ in the interconnecting leg in FIG. 2. The Figures should not infer that these are the only locations of the second, harder material in the weatherstrip, or that a greater or lesser amount of the second material could not be incorporated into the cross-section of the weatherstrip or there may be instances where distinct, multiple second material additions in the cross-section may be desired (see FIG. 3) and the use of distinct, plural second material additions 124′ that impact the control of the neutral axis of the entire cross-section which may include an extension of the body 140 that includes a continuation 142 of the core (a generally N-shaped or S-shaped core within a similarly configured body) and first and second seal lips 144, 146. Likewise, the weatherstrip may incorporate other structural features such as the bulb seal 126 noted above, sponge rubber seal lip 128, one or more retaining members or fingers 130 extending from either or both of the first and second legs 104, 106, or other design configurations that include still other structural features of the weatherseal without departing from the scope and intent of the present disclosure.

Providing a higher hardness material that is strategically placed around the carrier will support a compressive load and allow the weatherstrip designer to use lower cost carriers in applications where the less expensive carrier was not traditionally usable. Preferably this higher hardness material is a higher durometer rubber, plastic, or thermoplastic elastomer, but also achieves reduced weight of the final product, as well as reduced cost as noted above. Further, the ability to control the location of the neutral axis of the weatherstrip can be achieved without adding metal, undesired thickness, a weld, etc. to a conventional weatherstrip in an effort to control the neutral axis.

Without intending to limit the present disclosure, an exemplary embodiment of a weatherstrip 100 includes a generally U-shaped metal lanced and stretched carrier or core 120 that is at least substantially encapsulated in a body comprising a first material such as an elastomer 122 having a hardness in the range of 60-70 Shore A hardness. One of the legs 104, 106, 108 includes a region of a second material 124 that extends at least substantially across the cross section of at least one leg in a desired, preselected location in order to assist in controlling the location of the neutral axis. The second material has a hardness greater than the first material, for example in the range of 85-95 Shore A. A backbone of the lanced and stretched carrier provides some limited compressive strength to the weatherstrip but is deemed insufficient to carry all the desired compressive forces as may be required for neutral axis control of the weatherstrip. Consequently, the second material is provided to at least assist in supporting the compressive loads which impacts the location of the neutral axis. Thus, in this embodiment, the carrier carries the tensile loads and possibly a part of the compressive load while the second material is provided to carry a majority, if not all, of the compressive loads imposed on the weatherstrip.

In another preferred embodiment, the core is a wire carrier or cord which by its nature does not carry any compressive load, although it does carry the tensile loads. By strategically positioning the second material in this embodiment, the compressive load is adequately addressed by the second material and in a structure that normally could not accommodate design parameters that require compressive load capabilities.

In summary, the neutral axis is controlled by the tension carrying capacity of the strings/cord of the wire carrier and/or the semi-solid backbone of the lanced and stretched carrier. Along with the compression carrying capacity of the high durometer material, with the present disclosure it is conceivable to have the tension and compression carrying capacities in different areas of the carrier which is not possible with any other type of carrier. With a stamped and lanced carrier, the tension and compression carrying portion of the carrier are in the same place due to the location of the backbone. This could be a significant advantage and provides greater options for weatherstrip design and function.

It is also recognized that existing weatherstrips include different materials in the cross-section, however, these materials are not designed to control the ability to assist in the control of the location of the neutral axis of the weatherstrip. This is particularly true with regard to those weatherstrip designs that use string/cords for carrying tension forces but do not have a compressive load carrying capability.

The invention has been described with reference to the preferred embodiment. Modifications and alterations will occur to others upon reading and understanding this specification. It is intended to include all such modifications and alterations in so far as they come within the scope of the appended claims or the equivalents thereof.

Having thus described the invention, it is now claimed:

1. A weatherstrip comprising:
a body formed from an elastomeric first material having first, second and third interconnected legs generally forming a U-shape for receipt over an associated mounting flange of a vehicle;
a flexible carrier received in the elastomeric body for added strength, the carrier being unable to support compressive loads imposed on the body;
and wherein the body includes a second material having a different hardness than the first material of the body, the second material selectively positioned at a predetermined location in the U-shape for supporting compressive loads imposed on the body and thereby control the neutral axis of the weatherstrip.

2. The weatherstrip of claim 1 wherein the second material is a rubber.

3. The weatherstrip of claim 2 wherein the rubber is a higher durometer than the first material.

4. The weatherstrip of claim 3 wherein the rubber has a durometer of approximately 85-95 Shore A hardness.

5. The weatherstrip of claim 1 wherein the second material is capable of supporting the compressive loads of the weatherstrip.

6. The weatherstrip of claim 1 wherein the second material is a plastic.

7. The weatherstrip of claim 1 wherein the elastomeric material encapsulates the carrier.

8. The weatherstrip of claim 1 wherein the carrier is metal.

9. The weatherstrip of claim 8 wherein the metal carrier is lanced and stretched.

10. The weatherstrip of claim 1 wherein the carrier is a plastic.

11. The weatherstrip of claim 1 wherein the carrier is wire.

12. The weatherstrip of claim 1 wherein the carrier is generally N-shaped.

13. The weatherstrip of claim 1 wherein the weatherstrip includes the higher hardness second material at first and second spaced locations in the body.

14. A method of controlling a neutral axis in a weatherstrip that includes a carrier in an elastomeric material, comprising:
providing a carrier;
at least substantially encapsulating the carrier in an elastomeric first material; and
including a second material having a higher hardness than the first material to carry compressive loads imposed on the weatherstrip.

15. The method of claim 14 wherein the carrier providing step includes using a wire carrier.

16. The method of claim 14 wherein the carrier providing step includes using a metal carrier.

17. The method of claim 16 further comprising lancing and stretching the metal carrier.

18. The method of claim 16 wherein the second material defines a minor portion relative to the elastomeric material.

19. The method of claim 14 further comprising coextruding the first and second materials on the carrier.

20. The method of claim 14 further comprising selecting the second material from among one of a rubber, plastic and thermoplastic.
